(19) United States
(12) Patent Application Publication
(10) Pub. No.: US 2006/0048584 A1
(43) Pub. Date: Mar. 9, 2006

(54) Support for electrical/electronic means and/or electrical power supply means for a hand dynamometer tool, in particular for a torque wrench operating by breaking mechanical equilibrium

(76) Inventors: Bertrand Cupif, Antony (FR); Philippe Praudel, Longjumeau (FR); Jocelyn Vecchio, Vitry Sur Seine (FR)

Correspondence Address: WENDEROTH, LIND & PONACK, L.L.P., 2033 K STREET N. W., SUITE 800, WASHINGTON, DC, 20006-1021, US

(21) Appl. No.: 11/100,528

(22) Filed: Apr. 7, 2005

(30) Foreign Application Priority Data
Sep. 4, 2004 (FR) 04 03725

(51) Int. Cl. B25B 23/14

(52) U.S. Cl. 73/862.23

(57) ABSTRACT

A support for supporting electrical and/or electronic means and/or electrical power supply means for a hand dynamometer tool, in particular for a torque wrench operating by breaking mechanical equilibrium. A body of substantially cylindrical shape that extends along a longitudinal axis, defined by two end faces, recesses and/or seats suitable for receiving electrical power supply members and/or electrical/electronic circuit boards are arranged and distributed around said axis, on or close to the periphery of said support. Application to a support module for a hand dynamometer tool and to a dynamometer tool.

The present invention relates to a support for supporting electrical and/or electronic means and/or electrical power supply means for a hand dynamometer tool, in particular for a torque wrench operating by breaking mechanical equilibrium.

### BACKGROUND OF THE INVENTION

It is known that the electrical/electronic and/or electrical power supply means for a dynamometer tool comprise electrical/electronic circuits and components that are powered by batteries.

Such means are generally positioned flat, side-by-side, inside the tool or else projecting from the outside of the tool.

Such positioning suffers from the drawback of occupying a very large volume, which is detrimental to overall compactness.

In addition, access to other internal assemblies of the tool requires partial disassembly and complete removal of electrical power supply sources.

In this context, the present invention mitigates the drawbacks of the prior art by proposing a support for electrical/electronic means and/or electrical power supply means for a dynamometer tool, which support optimizes the volume occupied by said electrical/electronic means and/or electrical power supply means for the tool. In addition, a support of the invention makes it possible to reduce significantly the cost of industrially assembling together subassemblies for a dynamometer tool.

### OBJECTS AND SUMMARY OF THE INVENTION

To these ends, according to the invention, the support for supporting electrical and/or electronic means and/or electrical power supply means for a hand dynamometer tool, in particular for a torque wrench operating by breaking mechanical equilibrium, is wherein the support comprises a body of substantially cylindrical shape that extends along a longitudinal axis, and that is defined by two end faces, and wherein recesses and/or seats suitable for receiving electrical power supply members and/or electrical/electronic circuit boards are arranged and distributed around said axis, on or close to the periphery of said support.

According to other characteristics of the invention:

the recesses and/or seats are distributed radially and, in particular, facing outwardly relative to the longitudinal axis of the support;

the recesses and/or seats extend longitudinally along axes or planes parallel to the axis of the support;

the support is provided with at least one, and preferably three, longitudinal recesses suitable for receiving electrical power supply members;

the passageway is a duct extended at least on one end face of the support by a guide sleeve having a circularly tubular segment.

at least at one of its end faces, the support is provided with positioning means and/or with fastening means for positioning and/or fastening an electrical/electronic element perpendicularly to the axis of the support; and

the support is a one-piece part, in particular made of a plastics material;

The invention also provides a support module including a support as defined above, at least one electrical power supply member of the optionally rechargeable battery type, and at least one electrical/electronic circuit board, the at least one member and the at least one board being received respectively in the recesses/seats of the support.

The invention also provides a dynamometer tool for manually applying torque, said tool extending along a longitudinal axis and comprising:

a drive portion situated at the distal end of the tool and serving to co-operate with a tightening drive member for driving a fastener element;

a handle portion situated at the proximal end of the tool;

an intermediate portion;

an equilibrium-breaking mechanism suitable for delivering predetermined torsion torque to the drive portion, and a calibration device for calibrating bias means co-operating with the equilibrium-breaking mechanism and making it possible to set the set torque, the calibration device extending along the longitudinal axis of the tool; and

electrical/electronic means and/or electrical power supply means and/or measurement means and/or data management means and/or data transmission means;

the tool further comprising the above-defined support module, which module is disposed entirely inside the tool.

### BRIEF DESCRIPTION OF THE DRAWINGS

The invention will be better understood on reading the following description of an embodiment given by way of non-limiting illustration with reference to the accompanying drawings, in which:

FIG. 1a is a perspective view of a first embodiment of a support of the invention for electrical/electronic and/or power supply means;

FIG. 1b is a perspective view of the embodiment of the support shown in FIG. 1a as turned over through 180°;

FIG. 1c is a perspective view of the embodiment of the support in longitudinal section on line CC of FIG. 1b;

FIG. 2a is a perspective view of a variant of the first embodiment of a support of the invention for electrical/electronic and/or power supply means;

FIG. 2b is a perspective view of the variant embodiment of the support shown in FIG. 2a as turned over through 180°;

FIG. 3a is a view on a larger scale taken in cross-section on line A-A of FIG. 1a;

FIG. 3b is a view on a larger scale taken in cross-section through a second embodiment of the support;

FIG. 4a is a perspective view of a support module of the invention, showing the support of FIGS. 2a and 2b;

FIG. 4b is a perspective view of the embodiment of the support module shown in FIG. 4a as turned over through 180°;

FIG. 5 is an exploded perspective view of a hand tool of the invention;

FIG. 6 is a perspective view in semi-assembled mode of the tool shown in FIG. 5; and

FIG. 7 is a view in longitudinal section of the hand tool on line VII-VII of FIG. 6.

### MORE DETAILED DESCRIPTION

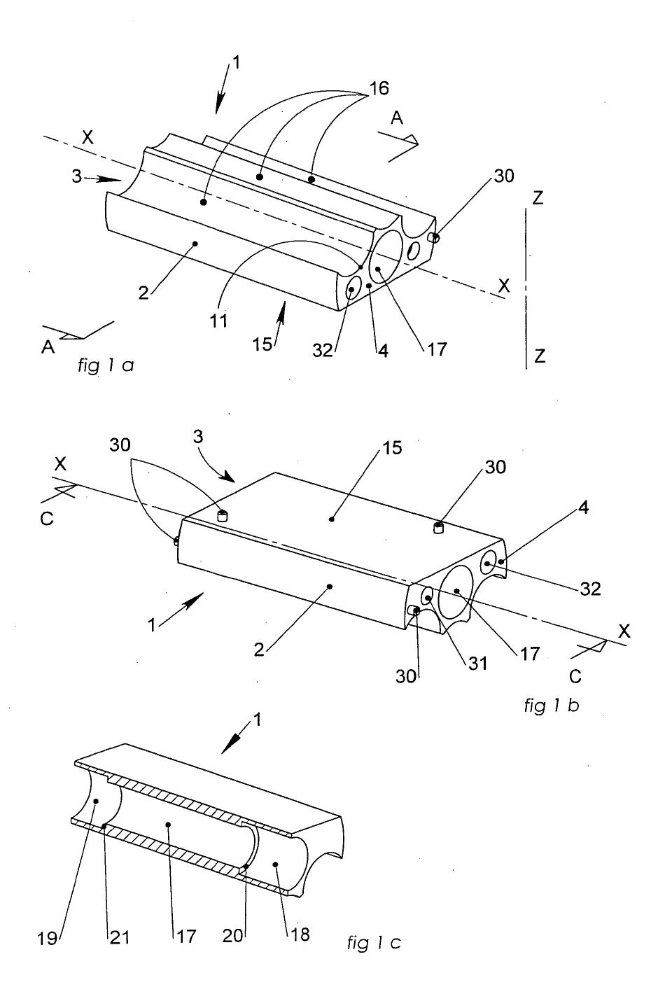

The support shown in perspective in FIGS. 1a and 1b is adapted to receive electrical/electronic means and/or electrical power supply means for a hand dynamometer tool.

The support 1 has a body 2 that is substantially cylindrical in shape and that extends along an axis X-X. The support 1 is defined axially by a first end face 3 and by a second end face 4, which end faces are substantially perpendicular to the axis X-X.

The body 2 is provided externally with a plane surface 15 parallel to the axis X-X forming a seat suitable for receiving an electronic circuit board, and with three cylindrical recesses 16 extending longitudinally along axes parallel to the axis X-X of the support 1, and suitable for receiving electrical power supply means such as optionally rechargeable batteries of the “AAA” type.

The recesses and/or seats are distributed about the axis X-X, at the periphery of the body 2, radially and facing outwardly relative to the longitudinal axis of the support 1.

In addition, the body 2 is provided with a central duct 17 of axis X-X that opens out in each of the end faces 3 and 4 of the body 2 and that makes it possible to pass a bit constituting a wrench or a screwdriver blade.

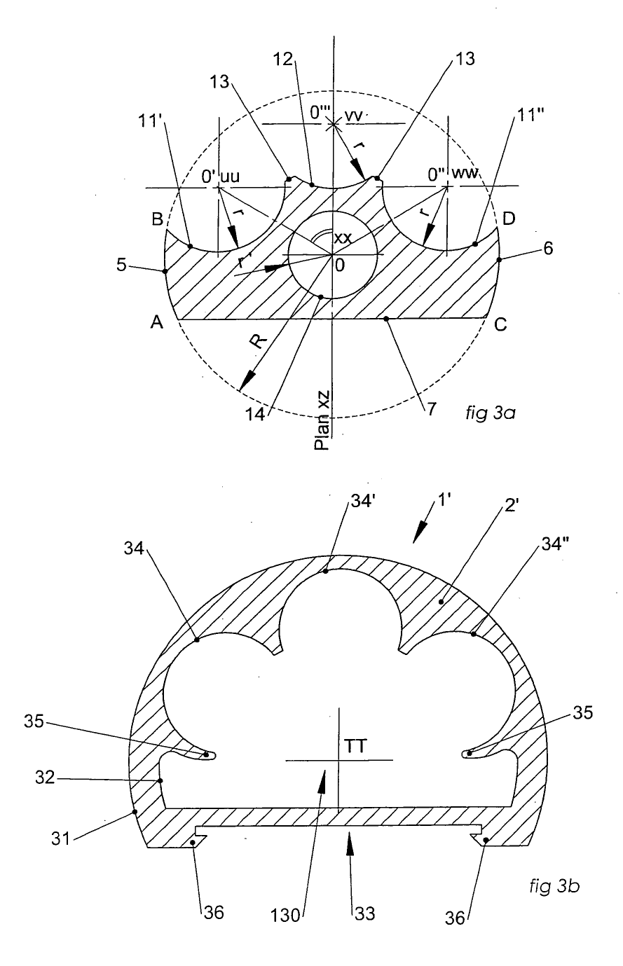

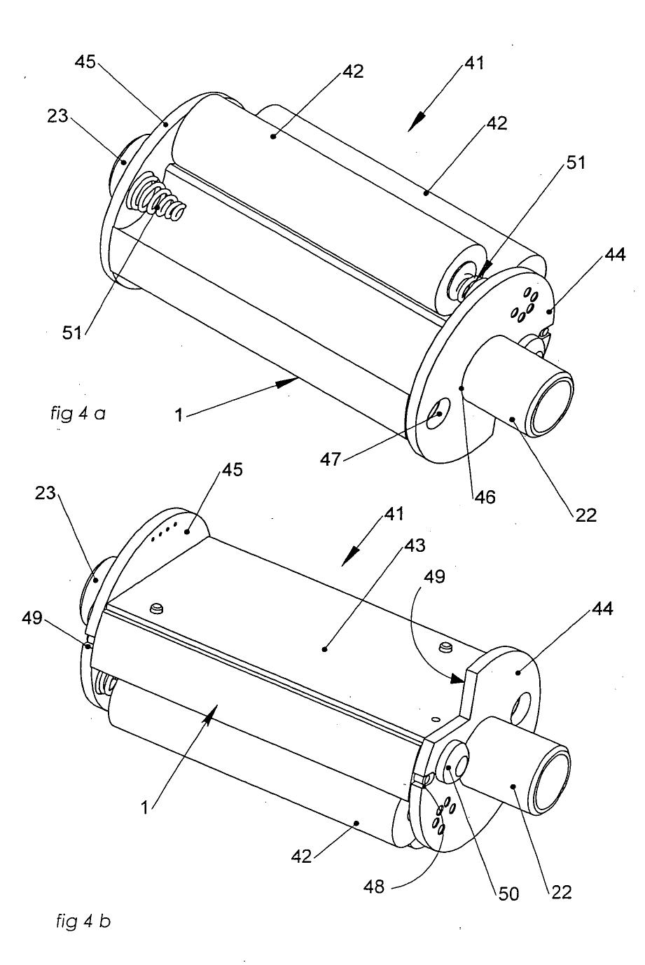

The outside surface of the body 2 has a closed profile as its base, shown in cross-section in FIG. 3a, the base being projected along the axis X-X of the body 2.

The outside profile of the body 2 is symmetrical about a plane XZ, the axis Z-Z perpendicular to the axis X-X being shown vertically in FIG. 1a. Said profile includes a first sector 5 and a second sector 6, which sectors are circular and of radius R, and are centered on a point O situated on the axis X-X of the body 2. The first sector 5 is defined by the end points A and B, and the second sector 6 is defined by the end points C and D. Said profile includes a straight line 7 perpendicular to the axis X-X of the body 2 and interconnecting two end points A and C of respective ones of the sectors 5 and 6, which points are situated symmetrically about the plane XZ. Starting from the other end point B of the sector 5, said profile includes a first sector 11′ that is circular, of center O′ and of radius r, where r is less than R, and that has its convex side facing towards the center O of the profile of the body 2. Symmetrically, starting from the other end point D of the sector 6, said profile includes a second sector 11″ that is circular, of center O″ and of the same radius r, and that has its convex side facing towards the center O of the profile of the body 2. A third sector 12, that is circular, of center O′″, and of radius r, and that has its convex side facing towards the center O of the profile of the body 2 is positioned such that the point O′″ is situated in the plane XZ, and that the points O′, O″, and O′″ are equidistant from the point O.

The three sectors 11′, 11″, and 12 of radius r are distributed angularly on either side of the plane XZ so that said sectors 11 if extended would substantially converge towards the sector 12, if extended, and in particular would converge tangentially.

Two segments 13 of small size connect the sectors 11′ and 11″ to the sector 12.

As shown in FIG. 3a, the base of the body 2 comprises a closed circular inside profile 14 of center O and of radius r′, situated inside the closed outside profile, the radius r′ being dimensioned to maintain a substantial distance between the line 7, the sectors 11′, 11″, and 12, and the inside profile 14.

As shown in FIGS. 1a and 1b, the plane face 15 is provided with two positioning studs 30 for positioning an electrical/electronic circuit board.

Similarly, each of the end faces 3 and 4 is provided with a respective positioning stud 30 for positioning an electrical/electronic circuit board.

In addition, the end face 4 is provided with a tapped blind hole 31 suitable for receiving a threaded member (not shown) for fastening an electrical/electronic circuit board to the face 4.

A second duct 32 that opens out in each of the end faces 3 and 4 makes it possible to pass a fastener member (not shown) serving to secure the support to another assembly of the tool.

In the embodiment shown in FIG. 1c, at each of its ends, the central duct 17 has a bore 18, 19 of radius slightly larger than the radius of the central duct 17.

A shoulder 20 connects the bore 18 to the duct 17, and a shoulder 21 connects the bore 19 to the duct 17.

The inside surfaces of the bores 18 and 19 form guide surfaces for guiding other assemblies of the tool.

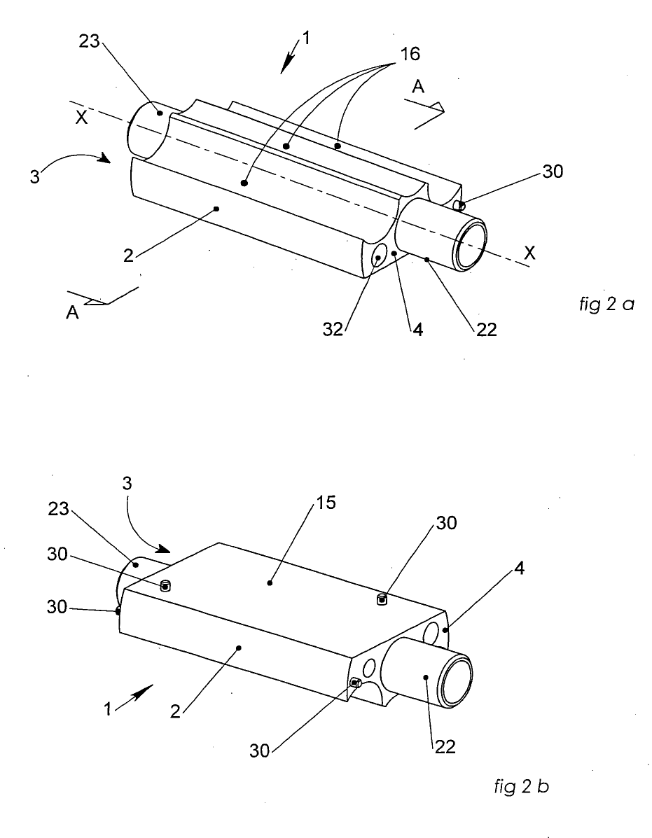

In a variant shown in FIG. 2a, the central duct 17 is extended at each of its ends by a respective tubular sleeve 22, 23 formed integrally and of outside diameter slightly larger than the diameter of the central duct 17.

The outside surfaces of the sleeves 22 and 23 form guide surfaces for guiding other assemblies of the tool.

The support 1 can be made in one piece, e.g. of an injection-molded plastics material.

In a second embodiment shown in cross-section in FIG. 3b, the support 1′ comprises a body 2′ of substantially cylindrical shape extending along a longitudinal axis T-T and having a central hollow zone 130.

The outside profile 31 is provided with a seat 33 for receiving an electrical/electronic circuit, and the inside profile 32 is provided with recesses 34, 34′, and 34″ for receiving electrical power supply means.

Deformable elements 35, 36 are suitable respectively for retaining the electrical power supply means in the recesses 34, 34′, and 34″, and for retaining an electrical/electronic circuit board in the seat 33.

The recesses and/or seats shown in FIG. 3b are also distributed angularly about the longitudinal axis T-T, close to the periphery of the body 2.

The duct 17 shown in FIGS. 1a to 1c and the central hollow zone 130 shown in FIG. 3b form a through passageway extending respectively along the axis XX and along the axis TT of the support 1 and 1′.

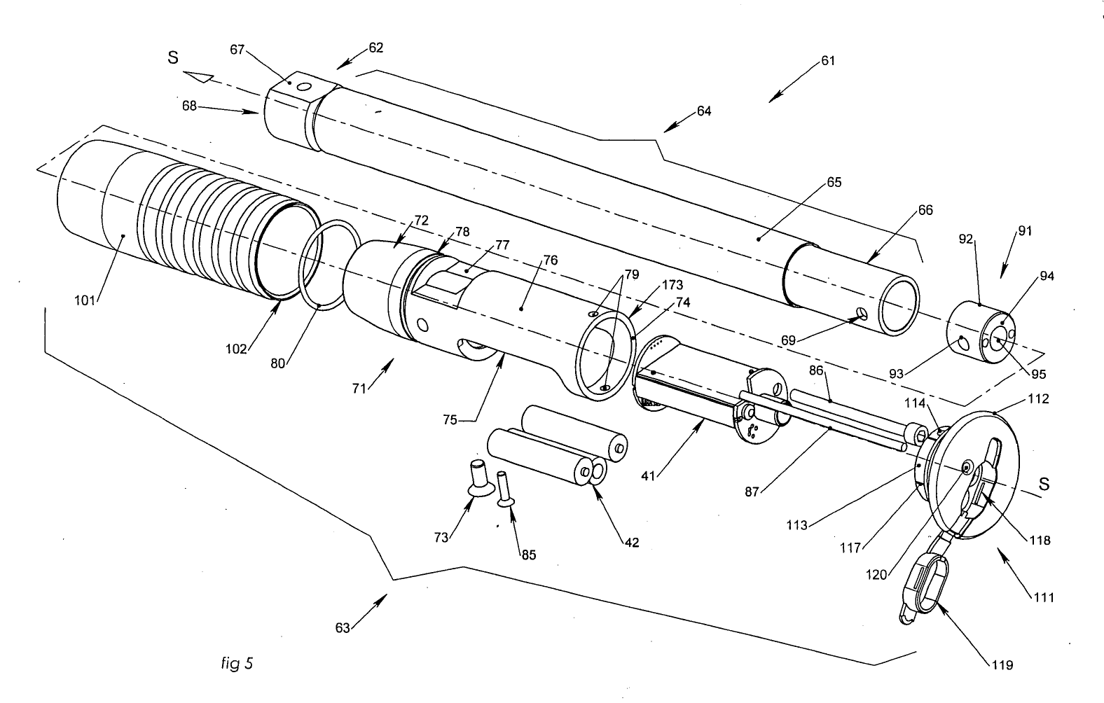

The support module 41 shown in perspective in FIGS. 4a and 4b comprises a support 1 according to FIGS. 2a and 2b.

The module 41 is equipped with three electrical batteries (only two of which are shown) in the form of optionally rechargeable batteries of the “AAA” type. The module 41 is also equipped with a first electronic circuit board 43 received in the seat formed by the plane face 15 extending in a plane parallel to the axis of the support 1. The module 41 is further equipped on each of the end faces 3 and 4 of the support 1 with a second electrical circuit board 44 and with a third electrical circuit board 45, which boards are positioned perpendicularly to the axis of the support 1.

The second circuit board 44 is provided with a first central orifice 46 of shape complementary to the shape of the tubular sleeve 22 of the support 1 and facing said sleeve 22.

The second board 44 is also provided with a second orifice 47 that faces the duct 32 in the support 1 and with an oblong notch 48 facing the positioning stud 30 on the end face 4 of the body 2 of the support 1.

The second board 44 is further provided with a third orifice (not shown) facing the tapped hole 31 in the support 1, and with a notch 49 making it possible to leave a passageway for passing electrical/electronic elements, such as a flexible antenna (not shown).

The third circuit board 45 is provided with a first central slot (not shown) of shape complementary to the shape of the tubular sleeve 23 of the support 1, and facing the sleeve 23.

The third board 45 is also provided with a second slot (not shown) facing the duct 32 in the support 1 and with an oblong notch 49 facing the positioning stud 30 on the end face 3 of the body 2 of the support 1.

A fastening element 50 is screwed into the tapped blind bore 31 in order to hold the second electrical circuit board 44 on the support 1.

Facing the positive terminals of two of the power supply members 42, the second circuit board 44 is provided with two electrical contact tabs (not shown). Facing the negative of a power supply member 42, the second circuit board 44 is provided with a deformable electrical contact element 51 resiliently urging the power supply member 42 in question.

Facing the positive terminal of a power supply member 42, the third circuit board 45 is provided with an electrical contact tab (not shown). Facing the negative terminals of the other two power supply members 42, the third circuit board 45 is provided with two deformable electrical contact elements 51 (only one of which is shown), which contact elements resiliently urge respective ones of the power supply members 42.

The assembly made up of the two electrical circuit boards 44, 45 and of the three power supply members 42 form an electrical power supply circuit for the first electronic circuit board 43.

A connection (not shown) electrically connects the electrical power supply circuit to the first electronic circuit board 43.

The first electronic circuit board 43 is further provided with a data transmission unit comprising radio means and at least one antenna (not shown).

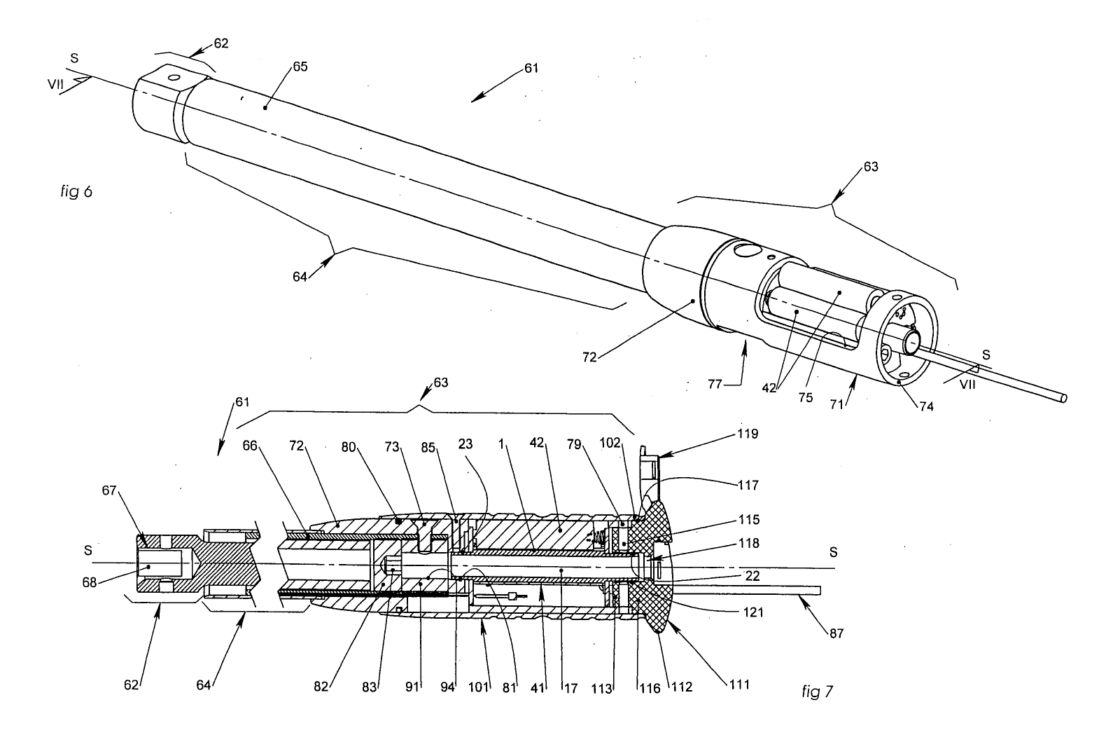

The hand tool 61 shown in FIGS. 5 to 7 is a dynamometer tool, in particular a torque wrench.

The torque wrench 61 extends along a longitudinal axis S-S extending from back to front relative to an operator of the wrench.

The wrench 61 essentially comprises a drive portion 62 situated at the distal or front end of the wrench 61, a handle portion 63 situated at the proximal or back end of the wrench 61, and an intermediate portion 64 in the form of an outer sheath or housing 65 covering an inner tube or bar 66 situated between the drive portion 62 and the handle portion 63.

The drive portion 62 is provided with a front block 67 projecting from the front of the sheath 65 and, at its front end, having an attachment 68 known per se, in which an actuator device (not shown) can be fitted and fastened. The actuator device is typically a reversible ratchet head onto which a tightening socket fits.

A back block (not shown) of the drive portion 62 can extend inside the intermediate portion 64.

Internal mechanical means connect the drive portion to the intermediate portion and to the handle portion. The mechanical means make it possible for an operator to transmit tightening torque to a fastener element by manually applying a force at the handle portion.

The internal mechanical means can be constituted in particular:

either by a flexion beam provided with measurement means as described in Patent FR 2 707 395 or FR2 538 741 to the Applicant, the corresponding wrench being referred to as an “electronic torque wrench”;

or by an equilibrium-breaking mechanism biased by a compression spring and equipped with a calibration device, the mechanism being as described in Patent FR 2 841 492 to the Applicant, the corresponding wrench being referred to as a “torque setting wrench” or a “disengagement torque wrench”;

or else by an equilibrium-breaking mechanism biased by a compression spring and equipped with a calibration device, the mechanism being as described in Patent DE 22 08 878, the corresponding wrench being referred to as a “break back torque wrench”.

The handle portion 63 includes a handle support 71 that is cylindrical in overall shape and that extends coaxially with the axis S-S of the wrench.

The distal end 72 of the handle support is received by being fitted over the tube 66 of the intermediate portion 64. A fastener element 73 secures the handle support 71 to the tube 66 of the intermediate portion 64. In the example shown in FIG. 5, an assembly element 91 that is cylindrical in overall shape and that extends coaxially with the longitudinal axis S-S of the wrench, is provided at its periphery with an external thread 92 suitable for co-operating with a thread provided on the inside wall of the tube 66.

On its periphery, the assembly element 91 is provided with a tapped bore 93 of axis perpendicular to the axis S-S of the wrench. The fastener element 73 screws into the tapped bore 93 in the assembly element 91 through an orifice 69 provided in the wall of the tube 66.

In addition, the proximal end face 94 of the assembly element 91 is provided with a central bore 95 opening out in the distal face of the assembly element 91 and whose function is described below.

The proximal end 173 of the handle support 71 has a tubular segment 74 extending longitudinally and of shape and of size adapted to receive the support module 41 defined above.

An elongate slot 75 is provided axially and at some distance from the proximal end face 74 over one half of the circumference of the outside wall 76 of the handle support 71.

On mounting the support module 41 in the handle support 71, the recesses 16 suitable for receiving the electrical power supply members 42 are positioned facing the elongate slot 75 in the handle support 71. This configuration makes it possible for the optionally rechargeable batteries 42 to be accessed rapidly.

After the support module 41 has been mounted in the handle support 71, a longitudinal fastening element 86 holds the support module 41 in position in the handle support 71 by passing through the duct 32 in the support 1 and through the orifices provided facing the duct 32 and in the above-defined second and third circuit boards 44 and 45 of the support module 41.

A setback 77 is provided between the slot 75 and the distal end, in that half-circumference which is opposite from the half-circumference in which the slot 75 is provided.

This configuration makes it possible to pass electrical conductors and to connect them to one of the electrical circuit boards 44, 45 positioned perpendicularly to the axis of the support 1 of the support module 41.

In the vicinity of the proximal end of the handle support 71, two holes 79 perpendicular to the axis S-S of the wrench pass through the wall of the tubular segment 74 of the handle support 71.

In addition, between the setback 77 and the distal end 72, the handle support 71 is provided with a groove 78 suitable for receiving a sealing gasket 80, such as an O-ring gasket.

The handle portion 63 also has a handle in the form of a sleeve 101, of shape and size suitable for fitting over the handle support 71, and fastened securely thereto by means of a radial fastener element 85. The proximal end 102 of the sleeve 101 projects slightly relative to the proximal end 74 of the handle support 71.

The handle portion 63 further includes a proximal stopper 111.

The proximal end of the stopper 111 has a circular radial flange 112 projecting radially relative to the sleeve 101.

The distal end of the stopper 111 is provided with a male portion 113 suitable for fitting into the tubular proximal end 74 of the handle support 71.

The stopper 111 also has an intermediate portion 116 whose male portion is suitable for fitting into the proximal female end 102 of the sleeve 101. A sealing bead 117 is formed on the outside surface of the male portion 116 and it co-operates with the inside surface of the sleeve 101.

The stopper 111 is further provided with a passageway 118 extending along the axis S-S of the wrench 61, and in alignment with the duct 17 in the support 1 of the support module 41. A lid 119 makes it possible to close off the passageway 118 through the stopper 111. The stopper 111 is also provided with a passageway 120 suitable for passing a flexible antenna 87 connected to one of the electrical/electronic circuit boards of the support module 41.

On mounting the stopper 111 on the handle support 71, two radial bores 114 provided in the distal portion 113 of the stopper 111 are positioned facing the holes 79 in the handle support 71 in order to enable pins 115 to be inserted and thus to secure the stopper 111 to the handle support 71.

As shown in FIGS. 5 and 7, the support 1 of the support module 41 is of the type shown in FIGS. 2a and 2b.

The longitudinal axes of the various parts coincide along the axis S-S of the wrench.

The sleeves 22, 23 of the support 1 position and guide the support module 41 respectively in the bearing surface 121 of the stopper 111 and in the bearing surface 81 of the handle support 71.

This configuration offers the advantage of allowing access to internal mechanical means 82 (FIG. 7), such as an internal calibration device for calibrating bias means (not shown) such as a compression spring. As shown in FIG. 7, the internal calibration device 82 for calibrating the bias means extends along the longitudinal axis of the tool. This arrangement makes it possible for an operator to insert a bit constituting a screwdriver blade or a wrench in order to access the calibration device 82 from the outside, e.g. in order to access the drive portion 83 of said calibration device 82, by passing successively and from the outside through the stopper 111, through the support module 41, and through the assembly element 91, via the duct 17.

It should be noted that the support described offers improved compactness compared with the known configurations, and that industrially assembling together subassemblies and assemblies starting from this support is economically very advantageous for a hand dynamometer tool manufacturer.

The above-described invention also applies to a torque screwdriver.

What is claimed is:

1. A dynamometer tool for manually applying torque, said tool extending along a longitudinal axis and comprising:
a drive portion serving to co-operate with a tightening drive member for driving a fastener element situated at the distal end of the tool;
a handle portion situated at the proximal end of the tool;
an intermediate portion;
electrical and/or electronic power supply and/or measurement and/or data management and/or data transmission means; and
a support module disposed totally inside the tool, and that comprises:
a support for supporting electrical and/or electronic means and/or electrical power supply means, which support comprises a body of substantially cylindrical shape that extends along a longitudinal axis, and that is delimited by two end faces, recesses and/or seats suitable for receiving electrical power supply members and/or electrical/electronic circuit boards being arranged and distributed around said axis, on or close to the periphery of said support, at least one electrical power supply member of the optionally rechargeable battery type, and at least one electronic circuit board being received respectively in the recesses and in the seat of said support;
wherein the support is provided with a through passageway situated on the axis of the support.

2. A tool according to claim 1, wherein the recesses and/or seats are distributed radially and, in particular, facing outwardly relative to the longitudinal axis of the support.

3. A tool according to claim 1, wherein the recesses and/or seats extend longitudinally along axes or planes parallel to the axis of the support.

4. A tool according to claim 1, wherein the support is provided with at least one, and preferably three, longitudinal recesses suitable for receiving electrical power supply members.

5. A tool according to claim 1, wherein the passageway is a duct extended at least on one end face of the support by a guide sleeve having a circularly tubular segment.

6. A tool according to claim 1, wherein, at least at one of its end faces, the support is provided with positioning means and/or with fastening means for positioning and/or fastening an electrical/electronic element perpendicularly to the axis of the support.

7. A tool according to claim 1, wherein the support is a one-piece part, in particular made of a plastics material.

8. A tool according to claim 1, wherein the module has at least a first electronic circuit board received in a seat extending in a plane parallel to the axis of the support.

9. A tool according to claim 1, wherein the module has at least a second electronic circuit board positioned perpendicularly to the axis of the support.

10. A tool according to claim 9, wherein at least the second electronic circuit board is provided with a contact tab for establishing contact with one of the terminals of at least the electrical power supply member.

11. A tool according to claim 1, wherein the module includes three electrical power supply members of the optionally rechargeable battery type, an electronic circuit board positioned parallel to the longitudinal axis of the support and two electronic circuit boards, each of which is positioned at a respective end of the module perpendicularly to the axis of the support.

12. A tool according to claim 11, wherein the two electronic circuit boards that are perpendicular to the axis of the support and the electrical power supply members establish an electrical power supply circuit for the first electronic circuit.

13. A tool according to claim 12, wherein at least one connection electrically connects the electrical power supply circuit to the electronic circuit board positioned parallel to the axis of the support.

14. A tool according to claim 1, wherein at least one of the circuit boards of the module includes a data transmission unit for transmitting data via radio means.

15. A dynamometer tool according to claim 1, wherein the support module is disposed inside the handle portion.

16. A dynamometer tool according to claim 1, wherein the handle portion comprises a handle support and a separate sleeve mounted thereon.

17. A dynamometer tool according to claim 1, wherein an equilibrium-breaking mechanism is suitable for delivering predetermined torsion torque to the drive portion, and wherein a calibration device for calibrating bias means co-operates with the equilibrium-breaking mechanism and makes it possible to set the set torque, the calibration device extending along the longitudinal axis of the tool.

18. A dynamometer tool according to claim 17, wherein the calibration device extends along the longitudinal axis of the tool.

19. A dynamometer tool according to claim 17, wherein the tool is provided with access means and with adjustment means for accessing and adjusting the calibration device from the outside.

20. A dynamometer tool according to claim 19, wherein the access means comprise a passageway provided through a stopper assembled at the proximal portion of the tool, which passageway extends along the longitudinal axis of the tool.

21. A dynamometer tool according to claim 1, wherein the support module further includes data transmission means for transmitting data by radio.

22. A dynamometer tool according to claim 1, wherein the tool is a torque wrench or a torque screwdriver.
